(19) United States
(12) Patent Application Publication
(10) Pub. No.: US 2008/0145824 A1
(43) Pub. Date: Jun. 19, 2008

(54) Computerized speech and communication training

(76) Inventor: Danny Varod, Kfar Yona (IL)

Correspondence Address: Danny Varod, Dolev 7, Kfar Yona, 40300, omitted

(21) Appl. No.: 11/956,294

(22) Filed: Dec. 13, 2007

Related U.S. Application Data
(60) Provisional application No. 60/870,101, filed on Dec. 15, 2006.

(51) Int. Cl. G09B 19/04; G09B 5/00

(52) U.S. Cl. 434/169; 434/185

(57) ABSTRACT

This invention provides a method for automated training speech and communication, including, but not limited to, pronunciation, intonation, speech fluency, dialect, accents and non verbal social conduct. This invention deals with the following problems: How to train a user to communicate in a specific region's dialect, accent and conduct, in scenarios similar to the ones the user is expected to encounter. How to train a user in building sentences that convey his thoughts. How to train a user to correctly pronounce given sentences, in a given dialect and accent. How to increase a user's confidence in his/her ability to communicate in a taught language. The method offers a solution for training users to communicate fluently in a desired environment, in a way that is both effective and fun.

### BACKGROUND OF THE INVENTION

This invention is related to computer games, in specific a category of computer games referred to as “quests” or “adventure games” (such as Sierra's™ King's Quest™ published in 1984 and Quest for Glory™ published in 1989). In quests a virtual world is displayed, in which the user has a representation, referred to as an “avatar”. The user can move his/her avatar around and interact, through actions with objects and characters. In this category of games there is a storyline in which characters can speak to the user, and the user is given options from which he/she can select what the avatar is to say to the characters. The storyline can consist of various paths and outcomes, and develops as the user is playing, according to the user's actions and selections.

The method of learning is related to the field of psychology. According to psychological findings (Reference, The Open University of Israel course books for Social Psychology), people learn how to act in various scenarios from previous experience in similar scenarios and from observing others. Also a person's confidence in his/her ability to perform certain activities improves with experience.

Research also shows that people learn from positive and negative consequences that follow their actions. These consequences are conceived as feedback from which people learn the appropriateness of their actions.

Many people learn languages at school or in courses. Although they learn how read and write, they gain no experience in conducting conversations in the studied language. They are therefore unable to conduct a fluent conversation in that language, either due to the inability to construct clear sentences that convey their thoughts, or low confidence in their ability to do so.

### DESCRIPTION AND OPERATION

### Claim 1—Interactive Scenario Based Teaching

Using a computer game like environment, a user can gain the experience he/she needs by encountering simulated scenarios, similar to ones he/she is lightly to encounter in real life. This teaches users how to communicate in similar scenarios and boosts their confidence in their ability to conduct conversations in that language.

By providing the user with positive and negative feedback, which can be in any visual or auditory form (particularly in forms that imitate possible real life reactions), the effectiveness of the teaching can be enhanced.

Another advantage of this method is that the learning experience becomes game like, and therefore a fun process, motivating the user to use it more and therefore learn more.

Scenarios vary according to the desired usage of the language. For example, they can simulate situations specific to a certain type of business in a specific region of the world, or encounters with people from a specific region of the world, or tourist encounters in a specific region of the world. This can be done by using virtual locations, characters and objects similar to those found in that region, and by writing scripts with many different optional continuations, all according to the customs and dialects of that region and line of business.

The virtual locations, characters and objects can be animated (drawn) or made using photographs and video recordings, using any 3D or 2D graphics program.

Since the user must learn to interact within the scenario, using a specific dialect, the teaching of various accents can be added. This can be done by sounding speech to the user in the desired accent. The user's pronunciation of words and intonation of sentences can be checked specifically according to the desired accent. This can be done using any database containing a phoneme breakup for each word required, in the desired accent.

Also, since the interaction is not limited to verbal interaction, non-verbal culture norms of the desired location can be taught by having the characters act accordingly and react to the non-verbal input from the user, such as what the user selects to have his/her avatar look at or touch.

### Teaching Speech to Users who Lack Reading and Vocal Comprehension Skills in the Desired Language

If the user is unable to understand the script, interpretations can be displayed in a language the user is more familiar with. As another option, definitions in the same language or images (a useful tool in teaching small children) can be displayed.

### Confirming the Correctness of the User's Sentences

### Difficulties

1. A difficulty with voice processing is correct recognition and confirmation of the words a user is uttering (covered by claim 2).

The main causes of this difficulty:
1.1. Identifying which sound the user is trying to utter.
1.2. Validating the correctness of the user's pronunciation of intonation:
   1.2.1. Variations between different people's voices.
   1.2.2. Variations between different people's accents.
2. A difficulty with automated teaching of a language is constructing legal sentences conveying the desired message (covered by claim 4).

### Claim 2—Confirming the Correctness of the User's Pronunciation and Intonation

### SUMMARY

This method is based on using the user's own past input as a reference of comparison to the user's current input. This is done by demonstrating to the user how to correctly pronounce basic sounds and by recording the user's utterances. These utterances are later used as a base for comparison in order to identify what the user is currently uttering. Using a phonetic dictionary of a dialect and accent the user requested to learn, the basic sound elements in each expected word are known. They can therefore be compared to previous recordings of the user to determine whether the user has pronounced the word using the correct basic sound elements. This correctness is relative to the requested dialect and accent. Basic elements identified as correct can be added to the recorded uttering used to identify future correctness, therefore expanding the amount of recordings available for comparison.

### The Solution

1. Asking the User to Utter Given Sentences
By asking the user to utter given sentences, the words the user is trying to utter are known. Since the words are known, the user's uttering must only be validated as correct, not recognized. These given sentences can also be sentences the user inputted, by selecting sentences or words using an input device, such as, but not limited to, a mouse, keyboard or joystick.

2. Overcoming Accents and Dialects
By letting the user choose which accent and dialect he/she wishes to learn, the user's speech can be validated as matching or failing to match the expected accent and dialect. Words pronounced in other accents and dialects can be considered mistaken, as they do not conform with the selected accent and dialect.

3. Overcoming the Voice
Each word can be broken up into basic speech units—phonemes, and the movements made by the face (lips, tongue and etc) can be broken up into basic units of speech in the visual domain—visemes. The user can be taught the correct pronunciation of each phoneme, using recorded correct pronunciations and recorded or animated visemes. The user's utterances can be recorded and used as a collection of samples of how the user pronounces each phoneme.
The user's pronunciation can then be checked, by comparing the vocal input of what the user is currently uttering with the prerecorded phonemes that match the expected phoneme. In this way, the user's utterances can be identified or simply confirmed as suitable or not. Since the user's own voice is used for a base of comparison, the variations between the current input and the reference of comparison is considerably small. The comparison can therefore be performed using a simple speech recognition engine. Most such engines work by comparing intensity levels in the time domain, or by comparing transformations of the user's input and samples to another domain, such as the frequency or wavelet domains. The sensitivity of the comparison can be determined as sensitivity in which similar phonemes recorded from the user's utterances are distinguishable.

The innovation in this method is the use of the user's own input for confirming correctness of future input. This makes the confirmation process more accurate and simpler to perform.

### Claim 3—Demonstrating to the User how a Word or Sentence Should be Uttered in the User's Own Voice

Recordings of a user that are gathered while requesting the user to utter given sounds, can later be used to synthesize how the user should utter given words, in a given dialect and accent.

Given a specific dialect and accent that the user is to learn and a phonetic dictionary for that dialect and accent, the basic sound elements in each desired word are known. A correct pronunciation of a word in the user's voice can be synthesized by playing the basic sounds, recorded from the user's utterances, that match the break down of the word that is to be synthesized. This can be used to demonstrate how a word or sentence should be uttered in his/her own voice.

### Claim 4—A Method for Teaching a User to Construct Grammatically Correct Sentences

### Building Correct Sentences

By allowing the user to build a sentence, using only given selections of word or word groups, the complexity of the grammar check is reduced. Also the meaning of the sentence can be more easily determined. The building of the sentence can be done by displaying or sounding possible choices for the next word or group of words. Using a collection of different types of sentences and sentence formations and a collection of words (i.e. subjects, objects and actions) that are relevant to the scenario's script, a tree of optional sentence components can be built. This tree contains a list of possible choices a user can make at each stage, until completing the sentence, by reaching one of the possible ends of the tree.

Each component in the tree is either a word, phrase, expression or a grammatical structure for the continuation of the sentence.

By displaying this tree to the user and having the user select (using any user input device i.e. keyboard, mouse, joystick, microphone and etc) a component from the current level of the tree, the user builds a sentence by progressing to the next level of the tree. If the tree is limited to correct grammatical structures with known meanings, only grammatically correct sentences can be built. The meaning of each sentence, relative to the subjects, objects and actions chosen is also known, enabling the scenario to continue according to the meaning of the user's sentence.

Since the sentence the user is meant to utter is selected in this way, the words the user is trying to utter are known and can therefore be used, together with a phonetic dictionary for verification of the user's pronunciation and intonation.

### SUMMARY

This invention provides a method that enables a user to acquire the communication skills he/she needs to communicate in a specific region. It provides training in the required dialect, accent and social conduct, in scenarios similar to the ones the user is expected to encounter.

This invention provides a method for teaching a user how to build sentences that convey his/her thoughts, by enabling him/her to select suitable and compatible components for a sentence.

This invention provides a method for training a user to correctly pronounce given sentences in a given dialect and accent. It introduces a method for checking the correctness of the user's speech and of demonstrating to him/her, how he/she should have said it.

This invention provides a method for increasing a user's confidence in his/her ability to communicate in the taught language, by providing experience and feedback.

This invention provides a method for making the learning experience fun and game like, which motivates the user to use it more and therefore learn more.

What is claimed:

1. An automated method for teaching users to speak and communicate, including but not limited to, the teaching of pronunciation, intonation, speech fluency, dialect, accents and non verbal social conduct.
Comprising of:
1.a. Interactive simulated scenarios based on probable real-life scenarios. These scenarios are suited to the user's desired usage for the communication skills in real-life. (For instance, for the type of scenarios the user is likely to encounter and for the types of locations and regions the user intends to go to). Scenarios can include locations, items and characters and can be animated/drawn and/or based on photographs and video recordings of locations, people and objects and contain storylines and character scripts. These scenarios can be simulated on a computer or any other system containing a processor, display device, sound device, and input device, such as a game consol with a television or a hand held device such as a cellular phone.
1.b. Ability for the user to interact with a character or many characters, in the simulated scenario, either physically, verbally, or both, using computer input devices, such as the keyboard, mouse, microphone, or any other input device.
1.c. Adaptive simulated scenarios, that react to the user's input (including actions and words), providing feedback to the user. Feedback can be, but is not limited to, text and audio messages, reactions from objects and characters in the scenario, and adapting the continuation of the scenario, by providing various storyline paths and various outcomes.
1.d. Usage of the feedback and results received for different purposes, such as demonstrating to the user how people would respond in real-life to such input, what the correct input for the desired result is, how to correctly build a sentence conveying the desired message and how to correctly speak the sentence, including the correct pronunciation and intonation.
The novelties of this method are:
A. Creating a teaching environment that mimics real life situations in the sense that the user's actions and speech affects the outcome of the situation the user is in, thus providing the user with a situation where he/she must use his/her communication skills to get to his/her goal.
B. Teaching the user social conduct in an automated manner.
C. Providing users with simulated scenarios that are adapted to their desired use of the language, thus providing a relevant experience in the use of the language.

2. An automated, online/run-time (during usage) method of confirming the correctness of the user's pronunciation and intonation.
Comprising of guiding the user to provide vocal input that can be used for confirming correctness of pronunciation and intonation.
The novelty of this method is using the user's own vocal input for confirming correctness of future input, thus making the process more accurate and simpler to implement.

3. Demonstrating to the user how a word, phrase or sentence should be uttered in the user's own voice.
Comprising of using the user's own past input for synthesizing a sentence in his/her voice.
The novelty in this is the use of the user's voice to teach/train the user.

4. A method for teaching a user to construct grammatically correct sentences.
Comprising of virtual trees of optional words and word groups, from which the user is to select one option at each level, until a complete structurally correct sentence is built.
The novelty of this method is enabling the user to construct his/her own sentences, as the user must do in real life, yet restraining the user's choices to a predetermined finite amount, that can be comprehended and checked by a computer.
